(19) United States
(12) Patent Application Publication
(10) Pub. No.: US 2024/0369205 A1
(43) Pub. Date: Nov. 7, 2024

(54) ILLUMINATING DEVICE

(71) Applicants: April Mitchell, Cedar Point, NC (US); Matthew Andersen, Omaha, NE (US)

(72) Inventors: April Mitchell, Cedar Point, NC (US); Matthew Andersen, Omaha, NE (US)

(21) Appl. No.: 18/778,124

(22) Filed: Jul. 19, 2024

Related U.S. Application Data
(63) Continuation-in-part of application No. 17/734,841, filed on May 2, 2022, now Pat. No. 12,044,395.
(60) Provisional application No. 63/182,910, filed on May 1, 2021.

(51) Int. Cl. F21V 3/02; F21V 5/04; F21V 11/00

(52) U.S. Cl. CPC F21V 3/026; F21V 5/04; F21V 11/00

(57) ABSTRACT

An illumination device may include, but is not limited to: a light projection device configured to be disposed at least partially within a shell portion, the light projection device including: at least one light source operably couplable to a power source; and one or more lenses configured to non-linearly distribute a light beam generated by the at least one light source onto an interior surface of the shell portion to generate an image.

### PRIORITY

The present application claims priority under 35 U.S.C. § 119(e) to U.S. Provisional Patent Application Ser. No. 63/182,910, entitled LASER ILLUMINATED INFLATABLE, filed May 1, 2021, naming April Mitchell as inventor, and U.S. patent application Ser. No. 17/734,841, entitled, ILLUMINATING DEVICE filed, May 2, 2022, which are incorporated herein by reference in their entirety to the extent not inconsistent herewith.

### SUMMARY OF THE INVENTION

An illuminating device may include a light emitting device (e.g., a laser) disposed within an enclosed structure which may be inflatable (e.g., a balloon). The light emitting device may configured to project light on an interior surface of an inflatable structures to display illuminated designs which advertise a product, convey a message, or display a shape or design.

### BRIEF DESCRIPTION OF THE DRAWINGS

FIG. 1A—shows an internal cross sectional view of an illuminating device with outer shell.

FIG. 1B—shows an external side view of an illuminating device with outer shell.

FIG. 2. —shows a side view of an image projection unit.

FIG. 3. —shows a normally-on electronic circuit with light source.

FIGS. 4A-4C. —show three progressive states of inflation of the illumination device.

FIG. 5. —shows an illumination device having a support frame disposed inside an elastomeric outer shell.

FIG. 6. —shows an illumination device having a support frame.

FIG. 7. —shows a cut-away view of an illumination device having a support frame.

FIG. 8—shows an exploded view of an illumination device having a support frame.

FIG. 9. —shows an illumination device having a support frame.

### DETAILED DESCRIPTION

The drawings and specific descriptions of the drawings, as well as any specific or alternative embodiments discussed, are intended to be read in conjunction with the entirety of this disclosure. The illuminating device may, however, be embodied in many different forms and should not be construed as being limited to the embodiments set forth herein; rather, these embodiments are provided by way of illustration only and so that this disclosure will be thorough, complete, and fully convey understanding to those skilled in the art.

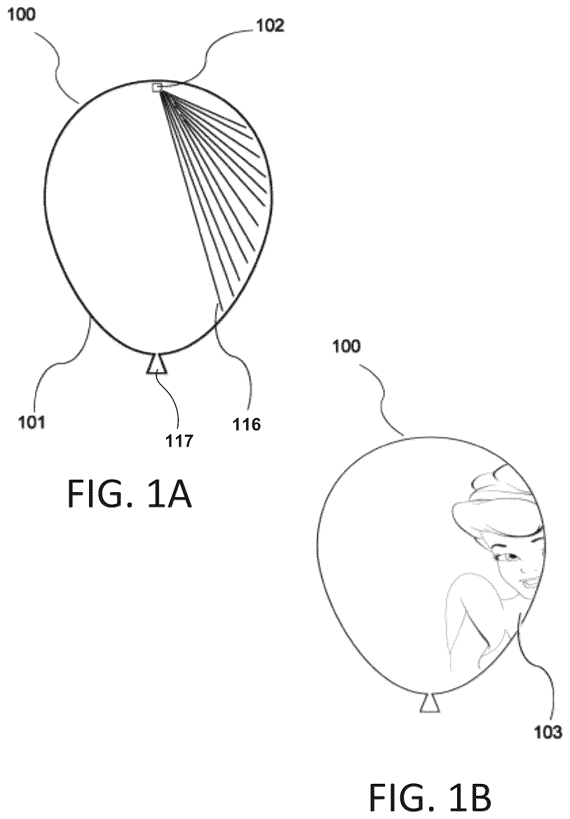

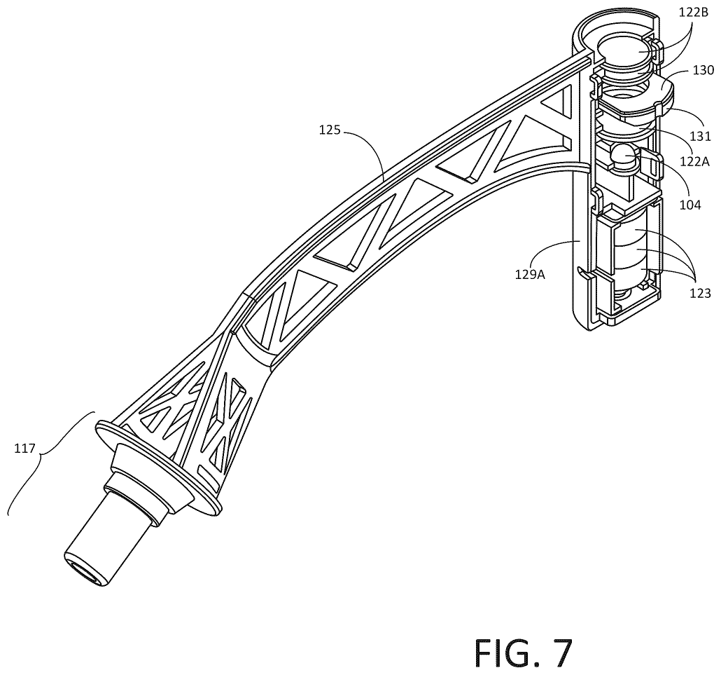

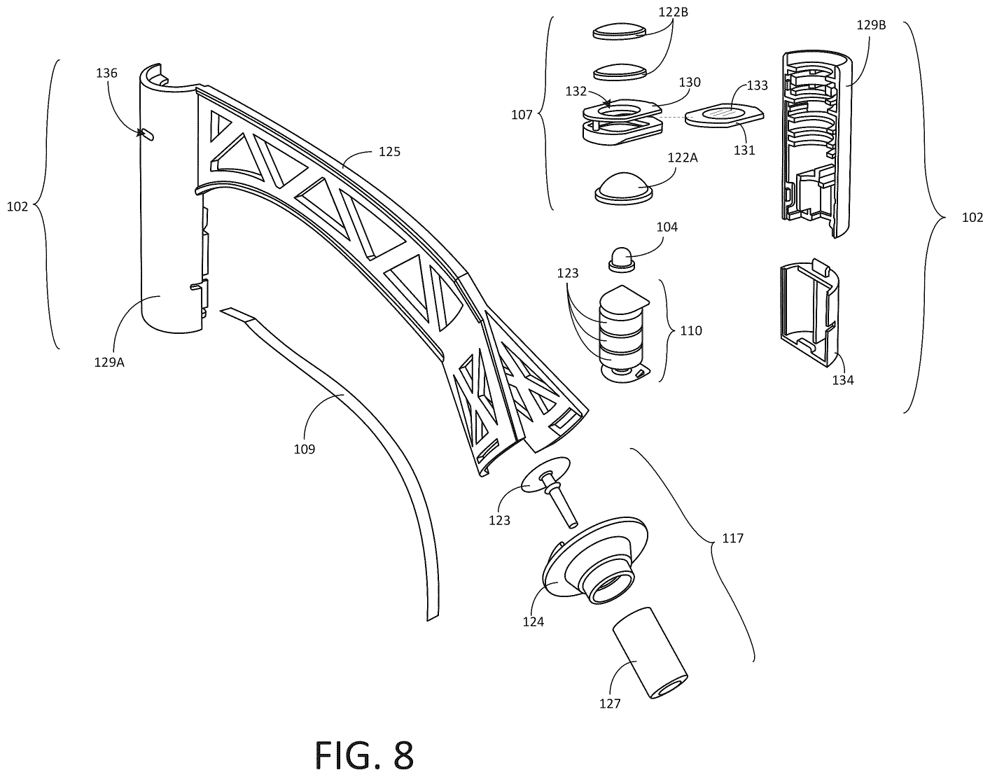

Referring to FIGS. 1-5, an illuminating device 100 may include one or more of the following components: a shell portion 101 (e.g., an inflatable or inflated shell); at least one image projection unit 102 including a light source 104 (e.g., a laser diode), a light path modification element 107 (e.g., a diffraction grating, at least one lens, at least one prism, and the like) and a power source 110 (e.g., one or more internal batteries 123 as shown in FIGS. 7 and 8, or connection to an external power source such as a wall outlet or light bulb socket).

An illuminated image 103 visible on the shell portion 101 may be generated by modifying (e.g., diffracting, refracting, reflecting, etc.) a concentrated light beam 105 (e.g., a laser beam) into a lesser concentrated controlled distribution 116 of light by modifying single-wavelength light waves from a light source 104. For example, the light path modification element 107 may be designed to provide a non-linear distribution of the light beam 105 that corresponds to a shape of the exterior shell portion 101 on which it may be projected. This correspondence may be defined by implementing a predetermined distribution designed in such a way that a light path modification element 107 having a varying focal length may be utilized to compose an appropriately adjusted image to substantially eliminate visual distortion that would normally occur when displayed on a curved surface of the shell portion 101.

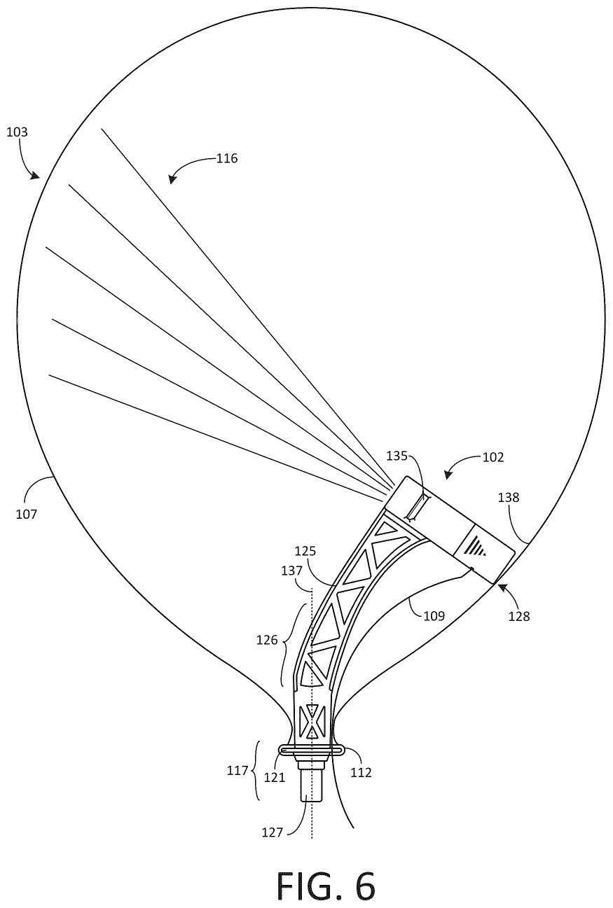

In the case of use of a balloon-type shell portion 101, a closure 117 may be provided which prevents gas from escaping from the shell portion 101 after inflation. The closure 117 may be applied to a filling port 112 of the shell portion 101 after gas may be used to expand the device to optimal size. Referring to FIGS. 6 and 8, in one example, the closure 117 may include a flange portion 121 having a diameter greater than the filling port 112 of the shell portion 101 when it is in a relaxed state, such that, upon stretching the filling port 112 around the flange portion 121, an elastic seal may be formed to both retain the image projection unit 102 in place relative to the shell portion 101 and restrict outflow of air from the shell portion 101.

Further, as shown in FIG. 8, the closure 117 may be include a one-way or check-type valve configured to receive air into the shell portion 101 but restrict flow out of the shell portion 101. For example, a plunger portion 123 may be received within a housing 124 where the plunger portion 123 may travel between an open position (when a pressure is applied from filling of the shell portion 101 via the port portion 127) and a closed position (when a pressure is applied via compression induced by an elastomeric shell portion 101) within the housing 124.

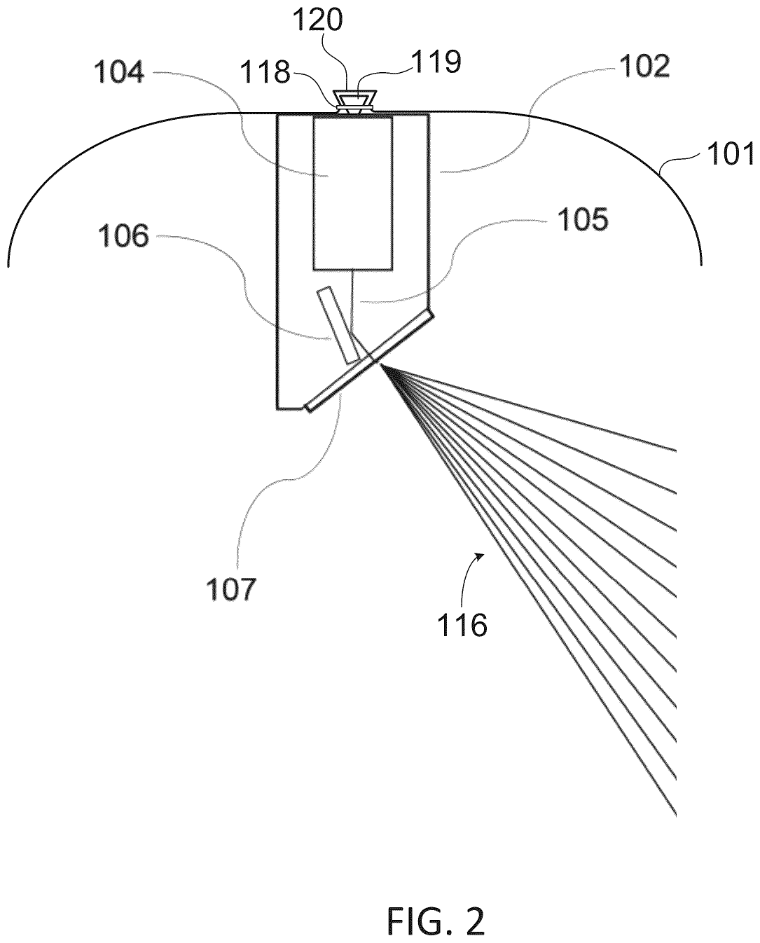

The image projection unit 102 may be internally mounted within the shell portion 101 via adhesion or other mechanical means. In one example, as shown in FIG. 2, the image projection unit 102 may be mounted to a wall of the shell portion 101 with a rubber band 118 that binds a small portion 120 of the wall material of the shell portion 101 to a small protrusion 119 on the image projection unit 102. In another embodiment, as shown in FIG. 6, the image projection unit 102 may be mounted to a support frame 125. The support frame 125 may be coupled to the closure 117 such that, when the closure 117 is received by the filling port 112 of the shell portion 101, the image projection unit 102, support frame 125 and closure 117 are retained in a substantially static position relative to the shell portion 101.

The support frame 125 may be configured such that the image projection unit 102 is directed in a specified direction (e.g., a desired inclination) relative to the interior surface of the shell portion 101 to optimize the projection and resulting optical characteristics of the illuminated image 103 on the shell portion 101. For example, the support frame 125 may have an at least partially angled or arcuate section 126 disposed between the closure 117 and the image projection unit 102. The section 126 may bend away from an axis 137, defined by the port portion 127 of the closure 117, toward an internal surface 138 of the shell portion 101 such that the image projection unit 102 may contact and be supported by the shell portion 101 at a contact location 128. Such a configuration may further maintain the positioning of the image projection unit 102 relative to the shell portion 101 to stabilize the optical characteristics of the illuminated image 103 on the shell portion 101.

The shell portion 101 may be semi-opaque in that an illuminated image 103 may be projected internally on the shell portion 101 via the diffracted light beam 105 but may be viewed on an external surface of the shell portion 101.

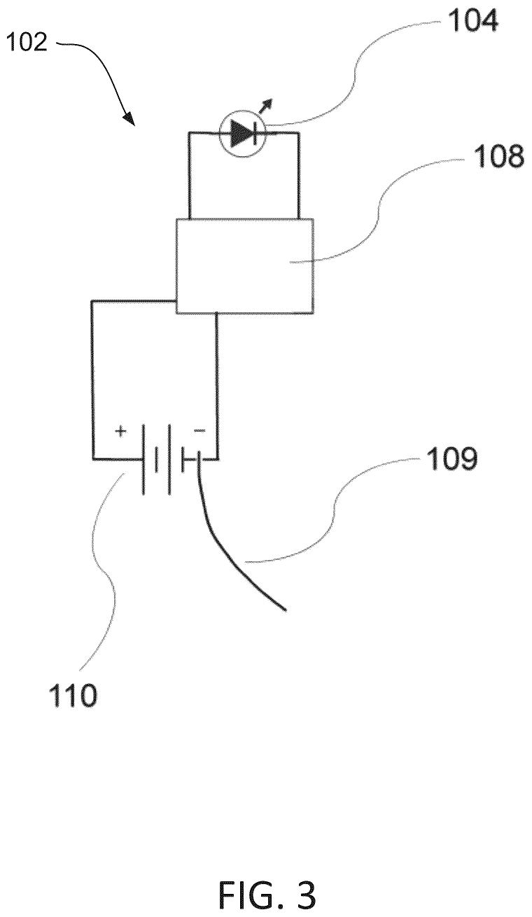

The shell portion 101 may be either manually filled (e.g., by blowing in air with a user's mouth, or placed on a gas distribution nozzle such as those found on electric inflation devices or helium tanks) via a port portion 127 of the closure 117, or may be mechanically inflated with a blow molding machine. Referring to FIG. 3, during the inflation process a release tab 109 blocking a battery connection 110 of the image projection unit 102 may automatically be removed from the battery connection 110 upon application of tension to the release tab 109 as the shell portion 101 increases in size. In another embodiment, the image projection unit 102 may be installed after the inflation process for the shell portion 101 is completed as in the case of blow molded embodiments. It should further be noted that an elastomeric balloon or a vinyl walled inflatable shell portion 101 or the like may be used to house the image projection unit 102 and display the illuminated image 103, including common toy balloons, shaped vinyl pool inflatables, and promotional advertising signs of various inflated shapes, and even thin walled toy balls. Blow molded embodiments may include a globe or other rigid shape which may be an integral component of a toy or other device, or may be a modular replaceable unit.

Referring to FIGS. 1A and 1B, internal and external views, respectively, of illuminating device 100 having the shell portion 101 are shown. The image projection unit 102 may distribute the light beam 105 onto an inner surface of the shell portion 101 forming an illuminated image 103 (e.g., of a person) visible from the outside of the shell portion 101.

FIG. 2 shows an image projection unit 102 containing a light source 104 (e.g., a laser source) which generates a concentrated light beam 105. A mirror 106 may be provided which is configured to reflect light beam 105 toward a light path modification element 107 which may split and/or redirect the light beam 105 into a controlled distribution 116 yielding a uniform proportion of separate elements (e.g., pixels) of the projected illuminated image 103.

FIG. 3 shows a normally-on image projection unit 102 with light source 104 (e.g., a laser diode) driven by light source driver circuit 108. The power source 110 (e.g., an on board battery or externally connected power source such as a power outlet or light bulb socket) may supply current to the driver circuit 108. A non-conductive release tab 109 may interrupt the driver circuit 108, thereby preventing the activation of light source 104 until the release tab 109 is be removed from the driver circuit 108.

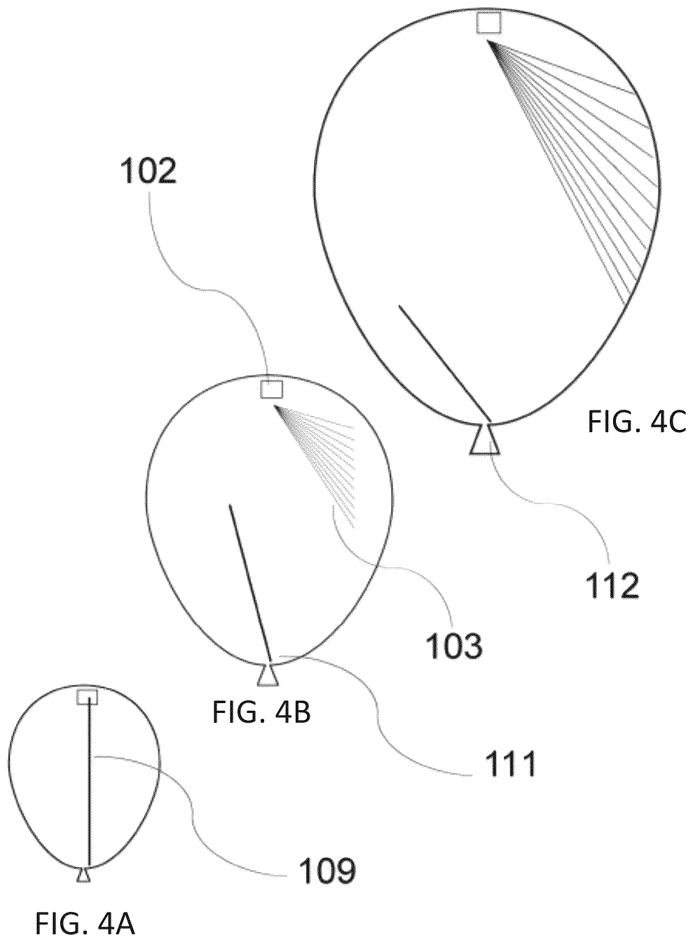

FIGS. 4A-4C depict progressive states of the illuminating device 100 ranging from un-inflated to fully-inflated. The release tab 109 is shown in the un-inflated device state of FIG. 4A as spanning a distance from the image projection unit 102 to the filling port 112. The semi-inflated device state of FIG. 4B shows the release tab 109 after release from the image projection unit 102 while still anchored to the shell portion 101 at contact location 111 and shows partial progress of the development of the illuminated image 103. The fully inflated device state of FIG. 4C shows the complete distribution of the illuminated image 103 on the shell portion 101 while the release tab 109 has fallen aside.

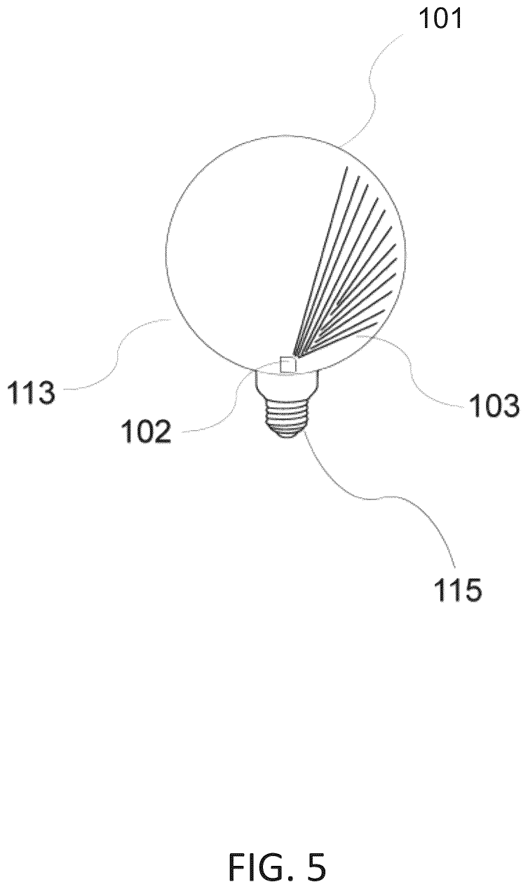

FIG. 5 shows an embodiment of the illuminating device 100 having a rigid, blow molded shell portion 101. The illuminating device 100 may include a screw-in light bulb-type base 115 coupled with the shell portion 101 and providing a power connection for the image projection unit 102 to an external wired power supply (e.g. ornamental light strings or used as part of a toy). The illuminated image 103 may be projected by the image projection unit 102 onto the rigid, blow molded shell portion 101.

In an alternate embodiment, a light sensitive switch may be integrated into the image projection unit 102 for the purpose of deactivating the image projection unit 102 unit automatically during bright ambient light conditions.

Referring to FIGS. 7 and 8, the image projection unit 102 may include a housing 129 (e.g., one or more housing portions 129A and 129B) which may contain the various optical components of the image projection unit 102. As noted previously, the image projection unit 102 may include a power source 110 (e.g., one or more batteries 123), a light source 104 (e.g., a multi-colored light-emitting diode), and at least one light path modification element 107. In one example, the light path modification element 107 may include one or more lenses. As shown in FIGS. 7 and 8, the light path modification element 107 may include a focusing lens 122A, and one or more magnification lenses 122B. The light path modification element 107 may include a slide holder 130 configured to removably receive an image slide 131.

The slide holder 130 may include an aperture 132 through which light emitted by the light source 104 may pass through an at least partially transparent image portion 133 (e.g., a photographic or image film) of the image slide 131 having an image disposed thereon, thereby generating the illuminated image 103. As described above, the focusing lens 122A, magnification lenses 122B, and/or image slide 131 may cooperatively operate to provide the non-linear distribution of the light beam 105 produced by the light source 104 so as to correspond to the shape of the exterior shell portion 101 on which the illuminated image 103 may be projected.

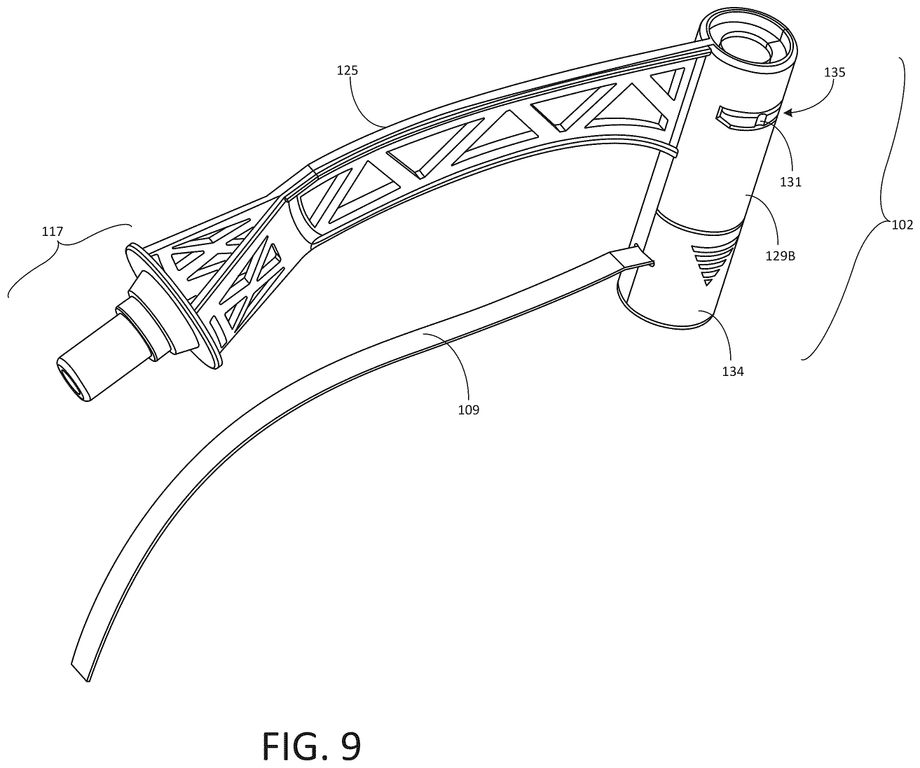

The removable nature of the image slide 131 may allow for reuse of the illuminating device 100 with alternate image slides 131 and/or alternate shell portions 101. For example, as shown in FIGS. 6 and 9, the housing portion 129B may include a slide slot 135 configured to receive an image slide 131 without having disassemble the image projection unit 102. As shown in FIG. 8, the housing portion 129A may include a release port 136 through which a release pin (not shown) may be inserted to force the image slide 131 out through the slide slot 135.

Referring to FIGS. 8 and 9, the image projection unit 102 may further include a battery cover 134 configured to secure the batteries 123 within the housing 129.

Different features, variations and multiple different embodiments have been shown and described with various details. What has been described in this application at times in terms of specific embodiments may be done for illustrative purposes only and without the intent to limit or suggest that what has been conceived may be only one particular embodiment or specific embodiments. It may be understood that this disclosure may be not limited to any single specific embodiments or enumerated variations. Many modifications, variations and other embodiments will come to mind of those skilled in the art, and which are intended to be and are in fact covered by this disclosure. It may be indeed intended that the scope of this disclosure should be determined by a proper legal interpretation and construction of the disclosure, including equivalents, as understood by those of skill in the art relying upon the complete disclosure present at the time of filing.

What is claimed:

1. An illumination device comprising:
a light projection device configured to be disposed at least partially within a shell portion, the light projection device including:
at least one light source operably couplable to a power source; and
one or more lenses configured to non-linearly distribute a light beam generated by the at least one light source onto an interior surface of the shell portion to generate an image.

2. The illumination device of claim 1, wherein the shell portion includes:
an elastomeric inflatable structure.

3. The illumination device of claim 1, wherein the shell portion includes:
a rigid structure.

4. The illumination device of claim 1, wherein the at least one light source includes:
a laser light source.

5. The illumination device of claim 1, wherein the non-linear distribution of the light beam corresponds to a shape of the shell portion so as to at least partially eliminate distortion of the image.

6. The illumination device of claim 1, wherein the one or more lenses configured to non-linearly distribute the light beam generated by the at least one light source onto the interior surface of the shell portion includes:
one or more lenses configured to non-linearly distribute the light beam generated by the at least one light source onto the interior surface of the shell portion to account for varying focal lengths associated with projection on a curved surface of the shell portion.

7. The illumination device of claim 1, further comprising:
a support frame operably coupled to the light projection device.

8. The illumination device of claim 7, further comprising:
a closure operably coupled to the support frame.

9. The illumination device of claim 8, wherein the closure includes:
a check valve.

10. The illumination device of claim 7, wherein the support frame includes at least one of an arcuate section or an angled section.

11. The illumination device of claim 10, wherein the at least one of an arcuate section or an angled section is configured to bend away from an axis defined by a port portion of a closure operably coupled to the support frame and toward an internal surface of the shell portion.

12. The illumination device of claim 1, wherein the light projection device further comprises:
a slide slot configured to receive an image slide in a light path of the light projection device.

13. The illumination device of claim 12, wherein the light projection device further comprises:
an image slide receivable within the slide slot.
